(19) United States
(12) Patent Application Publication
(10) Pub. No.: US 2016/0238194 A1
(43) Pub. Date: Aug. 18, 2016

(54) STORAGE DEVICE, GAS STORAGE UNIT AND METHOD FOR THE AT LEAST PARTIAL FILLING OR EMPTYING OF A GAS STORAGE UNIT

(71) Applicant: LINDE AKTIENGESELLSCHAFT, München (DE)

(72) Inventors: Robert Adler, Gerasdorf (AT); Georg Siebert, Wien (AT); Markus Stephan, Dornbach (AT); Michael Stefan, Zillingdorf (AT)

(21) Appl. No.: 15/026,425

(22) PCT Filed: Oct. 2, 2014
(86) PCT No.: PCT/EP2014/002688

§ 371 Date: Mar. 31, 2016

(30) Foreign Application Priority Data
Oct. 8, 2013 (DE) 10 2013 016 696.9

(51) Int. Cl. F17C 1/00; F17C 5/00

(52) U.S. Cl. CPC F17C 1/00; F17C 5/00; F17C 2221/012; F17C 2227/04; F17C 2201/0185; F17C 2201/019; F17C 2201/0195

(57) ABSTRACT

A storage device for storing a gas, in particular for storing gaseous hydrogen, having a first chamber for receiving the gas and a locking device for closing and opening a flow path connected to the first chamber. The storage device further has an adjustment unit for volume change of the first chamber. Further there is disclosed a gas storage unit which is the storage device wherein the gas is stored in the first chamber and to a method for the at least partial filling or emptying of the gas storage unit.

The present invention relates to a storage device for storing a gas, particularly for storing gas-phase hydrogen. The present invention further relates to a gas storage unit, comprising a storage device according to the invention. A further aspect of the present invention is a method for at least partially filling or emptying an inventive gas storage unit.

Conventional high-pressure gas storage are predominantly located in fixed positions and have a defined maximum volume. To take fall advantage of this volume, the storage units are filled to a maximum filling pressure, the nominal pressure rating of the storage unit. When gas is extracted from the storage unit the pressure is reduced by an amount equivalent to the quantity of discharged gas. This results in a constant pressure reduction over the duration of each filling. To ensure reliable function of a storage unit or a combined plant consisting of multiple storage units, a storage pressure well above the desired outlet pressure must be set. The lower the pressure difference between the respective storage pressure and the output pressure to be achieved, the more individual storage units must be interconnected in the “cascade”. The medium stored in the storage medium can only be used down to a minimum storage pressure that has a sufficient difference with respect to the desired output pressure. One of the results of this is that that not all of the gas volume in a storage unit can be made available. In addition, the load changes occurring during the emptying and filling of a storage unit have a life-shortening effect on the on the material of the storage unit due to the associated strain.

There is a clear trend in the automotive industry toward using alternative drives. One focus is the use of fuel ceils that convert hydrogen. As more and more vehicles begin, using fuel cells as a power source in the future, the greater the demand will be for storing hydrogen and the more load cycles the conventional storage will nave to withstand. These storage units, however, are only designed for conventional purposes and the load cycles known hitherto. In order to satisfy the greatly increased demand for hydrogen in the future, the storage units must therefore be modified to meet the more exacting demands of the future. The problem m this case, however, is that the materials for producing storage units and traditional storage designs are essentially cannot withstand greater stresses or more load reversals. In addition, the large number of storage units that will need to be kept available in future both for the purposes of the material to be used and production for manufacturing the storage units both have the effect of driving costs up. Similarly, the cost of filling and maintaining the storage units as well as transporting them is relatively expensive.

The object underlying the invention is therefore to provide a storage device and a gas storage unit, and a method for at least partially filling or emptying the gas storage unit according to the invention which enable the simple, reliable supply of stored gas, particularly hydrogen, cost-effectively and as required.

This object is with the inventive storage device according to claim 1 and the inventive gas storage unit according to claim 8, and by the method for at least partially filling or emptying a gas storage unit according to claim 9. Advantageous variations of the storage device are described in dependent claims 2 to 7. An advantageous variant of the method for at least partially filling or emptying a gas storage unit is specified in dependent claim 10.

The storage device according to the invention is used to store a gas, particularly for storing gas-phase hydrogen, and has a first chamber for holding the gas, and a shut-off device for closing and opening a flow path connected to the first chamber. According to the invention, it is provided that the storage device includes an adjustment unit for changing the volume of the first chamber. The adjustment unit can be used to adjust the volume of the first chamber to the quantity of gas present in the first chamber first chamber as it is being filled or emptied.

In this way, the gas pressure in the first chamber can be kept substantially constant. Consequently, the first chamber or the storage units comprising the first chamber is continuously exposed to substantially the same loads, so that its design can be adapted optimally for this constant load and may have a correspondingly long service life.

In a preferred variant of the embodiment, the adjustment unit has a second chamber for holding an additional fluid, and a separation device, wherein the first and second chambers are separated from each other by the separation device, and the variability in shape, size and/or position of the separation device in the event of a change in the volume of the second chamber enables an inverse change in the volume of the first chamber according to a certain ratio. This means that, for example, when gas is extracted from the first chamber and the volume of the first chamber decreases accordingly, the second chamber is essentially enlarged in complementary manner by the addition of a fluid into the second chamber. Similarly, when the size of the first chamber increases, the second chamber can increase in size of the first chamber, as a result of filling the first chamber with gas, for example, the size of the second chamber can be reduced in which case the fluid is discharged from the second chamber. The additional fluid is preferably a liquid. When the second chamber is being filled with the liquid, therefore, the first chamber is constricted by an incompressible environment, so that the volume of the first chamber is clearly defined by the volume of the second chamber.

In particular, in this context it may be provided that the first chamber is in the form of a tank and the second chamber is designed as an expansion device with variable shape and/or size. Alternatively, it is provided that the first chamber is designed as an expansion device having variable shape and/or size, and the second chamber has the form of a tank. In this context, the term tank is understood to be a container with rigid walls, of rigid construction, the volume of which is not changeable. In both variants cited, the variable expansion device is designed such that its size and/or shape are elastic and reversible so that it can automatically return to its initial size and initial shape after expansion. In the cited variants, the separation, device is defined by the tank.

In a further possible embodiment, the first and second chambers are arranged in a vessel, and separated from each other by a membrane that is variable with regard to its shape and/or size, or by means of a displaceable piston or by means of a bellows having variable size. In this configuration, the first and second chambers are constricted by the inner wall of said vessel, as well as by a respective side of a membrane that is arranged between the first chamber, and the second chamber. The separation devices in these cases are the membrane, the piston and the bellows respectively. The volumes of the individual chambers vary in a ratio of 1:1 when a membrane or bellows is used as the separation device, and in each case a complementary change in size of the first and second chambers takes place. In the case of pistons with different diameters, which are mechanically coupled to one another, a hydraulic transmission ratio may be implemented between the pistons, so that the ratio of the chamber changes may not be equal to a ratio of 1:1.

In a further embodiment, the adjustment unit, has an additional fluid, particularly ionized liquid, in a chamber of the storage device, and the additional fluid delimits areas of the first chamber. In this embodiment it is provided that the gas and the additional fluid are in the chamber together. Thus, the additional fluid contacts the gas in the first chamber directly with the result that it is possible to keep the gas at a given, preferably constant pressure as a function of the volume of the other fluid.

In another possible variant, the adjustment unit comprises a restrictor element and a drive member coupled mechanically to the restrictor element, wherein the restrictor element partially restricts the first chamber and is variable in terms of its shape, size and/or position by means of the drive member. This restrictor element may also be a piston or a bellows that is mechanically moved into the first chamber to keep the pressure in the first chamber essentially constant by reducing the volume of the first chamber when gas is taken out and the pressure in the first chamber consequently falls. This means that, unlike the variants described previously, a second chamber with additional fluid is not present in this variant.

In order to supply the storage device, the storage device should further include a pump, with which additional fluid can be supplied to the storage device. In addition, the storage device should have a pressurization controller in order to enlarge the first chamber for holding gas, and with which additional fluid may be discharged from the second chamber of the storage device and a drain in a controlled or regulated way.

Another aspect of the present invention is a gas storage unit comprising a storage device according to the invention, in the first chamber of which gas is stored, especially hydrogen if the storage device of the gas storage unit should comprise a second chamber, additional fluid, particularly a liquid stored therein.

A method for at least partially filling or emptying a gas storage unit according to the invention is also provided, according to which when a volume flow of gas is introduced into the first chamber or transported out of the first chamber the volume of the first chamber is altered by means of the adjustment unit in such manner that the gas pressure in the first chamber is maintained substantially constant. The gas pressure is preferably kept exactly constant, but pressure variations of about 10,000 kPa are permissible.

The outlet pressure may be lowered by reducing the pressure in the second chamber. If this is below a threshold that is significant for the number of load cycles of the respective pressure vessel, this reduction may be carried out.

In a variant of the adjustment unit with a second chamber for receiving an additional fluid as well as a separating device, a fluid volume flow into or out of the second chamber is used to change the volume of the second chamber, and also change the volume of the first chamber inversely as a function of the changed shape, sine and/or position of the separation device This means that when the pressure of the gas in the first chamber changes, the size of the second chamber is changed in such a way that the second chamber has a volume such that it restricts the volume of the first chamber to a size that substantially creates a pressure in the first chamber depending en the quantity of gas in the first chamber, which was set before the gas was extracted from or introduced into the first chamber, in this way, the pressure in the first chamber say be kept substantially constant, irrespective of the quantity of gas in the first chamber.

If the adjustment unit variant includes a membrane with variable shape and/or size or a displaceable piston or a resizable bellows, the membrane, the piston and the bellows delimit the first chamber from the second chamber, and are moved by pressurization from the additional fluid in such manner that the volume of the first chamber is adapted to the respective, quantity of gas extracted or added, and enables the pressure in the first chamber to be kept substantially constant.

If the adjustment unit variant includes an additional fluid, particularly an ionized liquid, and the common chamber for the gas and the additional fluid, when the gas pressure changes in the chamber additional fluid is introduced into the chamber or extracted therefrom, so that the volume in the chamber available to the gas is adjustable such that the gas pressure in the chamber remains substantially constant.

If the adjustment unit variant includes a restrictor element with variable shape, size and/or position which at least partially restricts the first chamber, when the gas pressure changes in the first chamber the restrictor element is shifted in such manner that the volume available to the gas is restricted to such a degree that the gas pressure remains substantially constant.

Some of the embodiments described are based on the fact that to the degree possible the gas is to be kept under constant pressure by means of another fluid, preferably a liquid, when the gas is extracted. In this context, the additional fluid in direct operative cooperation with the gas pressure in the storage device. The storage device has two ports, namely a first port for the introduction and extraction of the gas, and a second port for producing volume flows of the additional fluid. The pressure in the first chamber is advantageously kept permanently at least at the desired minimum output pressure of the storage device by means of a high-pressure pump through the second port. If a compressor were to be installed before the storage device, the final pressure of the compressor should preferably be greater than the storage pressure of the high-pressure pump, so that gas may be fed to the storage device.

With such a gas supply, excess additional fluid is extracted from the system using a pressurization controller.

The method for at least partially filling and emptying the gas storage unit can be carried out in such manner that the fluid quantity displaced or introduced by the high-pressure pump is measured by measuring instrumentation. This fluid quantity can be used to determine the quantity of gas that was extracted or added during the respective emptying or filling operation. The differential fluid quantity can be measured in the unpressurized state, wherein a mass measurement method may be used, for example by placing the liquid tank on a scale, or also fill level measurement or liquid mass flow measurement. Indirect mass measurement can be carried out relatively accurately, and the measurement unit of the gas extracted or added is calculated with due consideration for the ambient temperature. A quantity determination may be made with a high degree of accuracy here due to the greater density of the additional fluid.

When gas is extracted from storage device, the installed high-pressure pump maintains the pressure in the first chamber of said storage device constant. The gas thus remains available under constant pressure. In this way, the entire volume of the first chamber can be extracted at a constant pressure. If the respective holding device, in the form of a flexible bladder for example, does not have the capacity for the full quantity for storage, the pressure falls at the end of the gas extraction. This can be detected either by a closing valve on the bladder or also by a pressure measurement in the flow path of the gas. In this case, the volume of the first chamber of the storage device is exhausted, and it should not be emptied further, so that re-filling is necessary. Depending on the actual degree of emptying, a load change does take place here, but far fewer such load changes take place over the average life cycle of the storage device according to the invention than in conventional storage devices. The storage device according to the invention is preferably designed for high endurance in operation within a certain pressure range designed and consequently has a theoretically infinite service life.

The use of the storage device according to the invention allows the storage volume thereof to be exploited more efficiently. This means that effectively a larger amount of gas can be stored for the same cost of materials as with conventional storage devices, so fewer filling operations are necessary. In addition, the respective transport costs for an entire system can be minimized and it is possible to deliver systems without support fluid.

However, an essential advantage of the storage device according to the invention is that the number of load changes is reduced. Because of their high material stresses due to load changes they undergo, conventional storage devices have relatively low permissible load change numbers. Their service life is therefore very limited by frequent filling, with vehicle refueling, for example. The inventive storage device keeps the pressure reservoir under constant pressure, so that substantially the pressure reservoir is not exposed to any load changes caused by the storage device.

The advantages of the storage device according to the invent ion also have implications tor downstream systems. Existing units that are coupled, with storage facilities, such as compressors and fuelling pressure regulators, must withstand fluctuating pressure conditions. This affects either the efficiency or also the service life of the compressor and the ramp controller. With constant outlet pressure from the storage device, the design of the compressor is greatly simplified because it no longer has to adapt to changing pressure conditions. Moreover, the control effort is drastically simplified. The fuelling pressure regulator can work under constant pressure conditions. Besides simplifying control and regulation, these processes may now be designed to run more quietly, that is to say more smoothly. In addition, regulation-related thermodynamic changes can be calculated in direct relation to the constant outlet pressure.

The pressure ramp interruptions that are necessary with conventional storage cascading when switching from one storage cascade to the next—also called bank switching—can be prevented with the inventive system. If necessary, entire cascades or bank systems together with their regulation equipment can be dispensed with through the use of the entire storage volume of the storage devices. Moreover, the pressure smoothing results in few or even no thermal influences when the respective storage devices or cascades are filled or emptied.

Very small “pressure ramps” can be created by controlling the compressor and/or the high-pressure pump at the end of a gas supply operation to the storage device by introducing or extracting a certain quantity of the additional fluid in the adjustment unit to change the volume of the first chamber with such a speed profile that the desired flat pressure ramp is formed in the first chamber.

With a correspondingly designed connected pressure regulator, the storage device can be adjusted to various storage pressures.

In order to determine the quantity of gas supplied to or extracted from the storage device, the differential quantity of additional fluid can be used as a measurement of the differential gas quantity instead of using a mass flow meter. Either the weight of the additional fluid in the second chamber or the fill level in said second chamber may serve as a reference value.

In addition, the current capacity of a compressor when transporting the gas can be better measured by the displaced fluid without an additional mass flow. On this basis, conclusions can be drawn about the state of the gaskets and valves used. When the storage device is in the resting state, a possible, undesirable gas leak in the storage device may be detected by monitoring the additional load on the pump output.

In the following, the invention will be explained with reference to the exemplary embodiments illustrated in the accompanying drawing.

In the drawing:

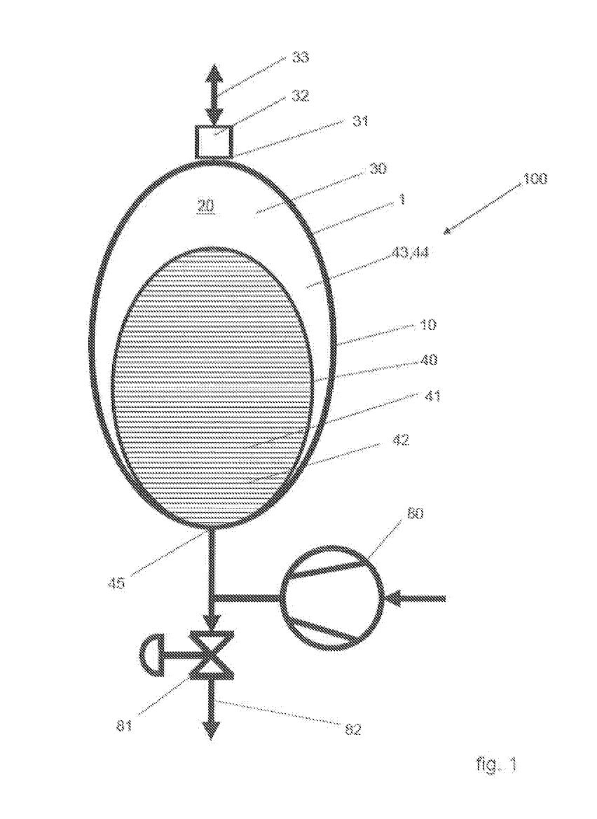

FIG. 1 shows a first embodiment of a gas storage unit according to the invention with bladder accumulator;

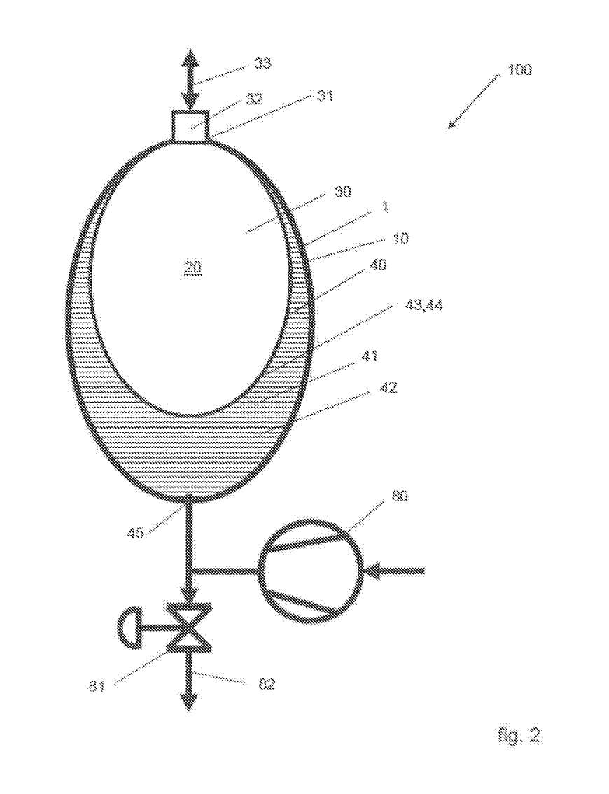

FIG. 2 shows a second embodiment of a gas storage unit according to the invention with bladder accumulator;

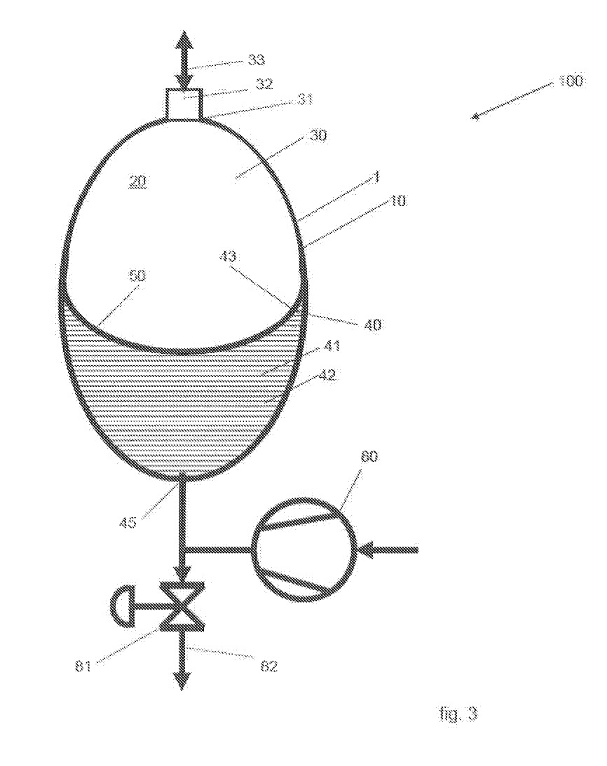

FIG. 3 shows a gas-storage unit according to the invention with membrane;

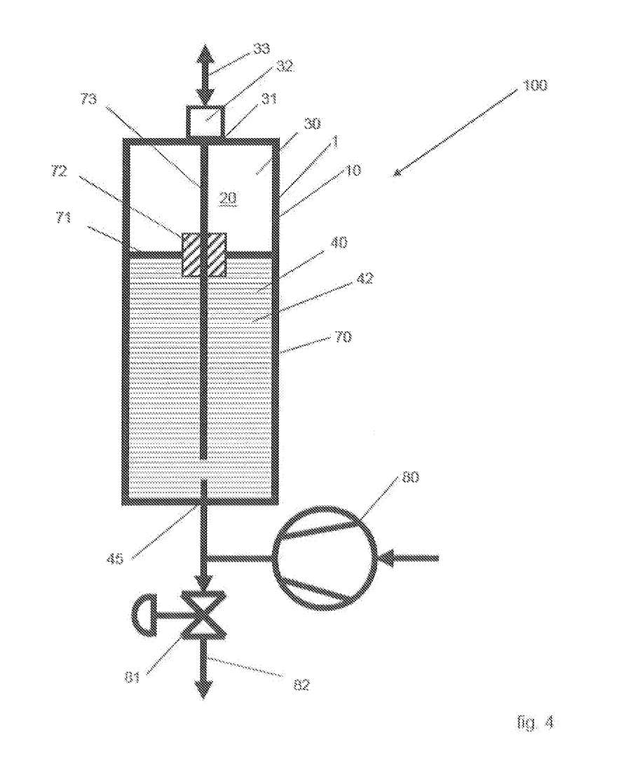

FIG. 4 shows a gas-storage unit according to the invention with only one chamber and a float; and

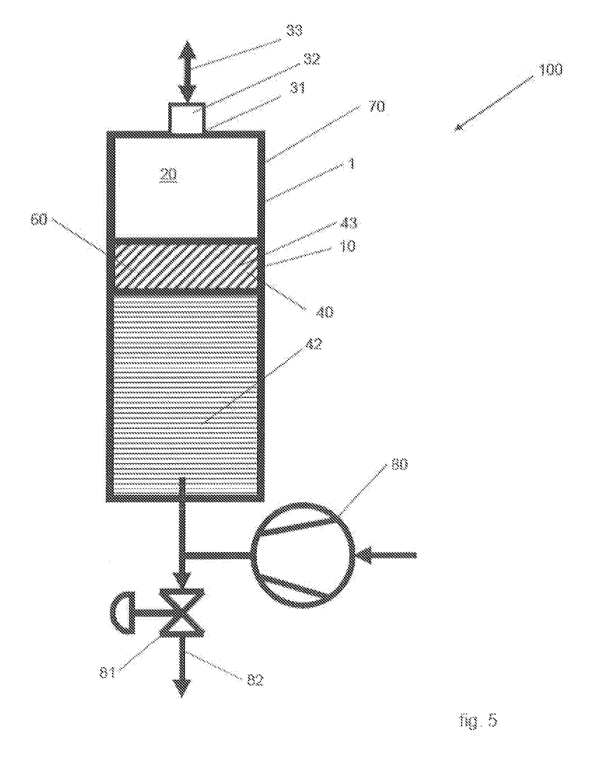

FIG. 5 shows a gas-storage unit according to the invention with only one chamber and a piston arranged therein.

Both embodiments of the inventive gas storage unit 100 shown in FIGS. 1 and 2 have a storage device 1 according to the invention, comprising a vessel 10 and a receiving device 44 in the form of a bladder, arranged inside said vessel 10. A first port 31 and a locking device 32 are arranged on vessel 10, creating a flow path 33 for a gas 20 that is to be held in storage device 1. A second port 45 is also present on vessel 10, with which port a pressurization controller 81 and a pump, preferably a high-pressure pump 80 is in flow-connection. The embodiments of FIG. 1 and FIG. 2 differ from each other to the extent that in FIG. 1 the gas is received in a first chamber 30, which is delimited by the inside of vessel 10 and by the outside of receiving device 44. In FIG. 2, this first chamber 30 for receiving gas 20 is only delimited by the inner side of receiving device 44.

In FIG. 1, a second chamber 41 for holding the additional fluid 42 is defined by the volume of receiving device 44. In FIG. 2, second chamber 41 for holding the additional fluid 42 is defined by the inside of vessel 10 and by the outside of receiving device 44.

In both embodiments, receiving device 44 here also serves as the separating device 43 for separating first chamber 20 from second chamber 41.

When gas 20 is introduced into first chamber 30 of storage device 1 according to FIG. 1 additional fluid 42 is discharged from second chamber 41 through outlet 32 by operating pressure control regulator 31 to maintain constant pressure in first chamber 20.

When gas is extracted from first chamber 20, additional fluid 42 is added to second chamber 41 by actuation of pump 80, so that in this situation too, the pressure of gas 20 can be kept constant in first chamber 30.

In the two embodiments illustrated in FIGS. 1 and 2, therefore, an adjusting unit 40 is created, which comprises receiving device 44 and additional fluid 42.

Receiving device 44—which according to the embodiment in FIG. 1 is configured as a bladder—is adaptable to the geometry of vessel 10 and first chamber 30, and this embodiment is therefore the solution that enables the greatest possible efficiency with regard to gas storage. The material of the receiving device itself can be left unpressurized due to the pressure equilibrium of the surrounding media, so that a structure of receiving means 44 from a relatively thin material, such as a rubber membrane, is possible.

The embodiment shown in FIG. 2 has the advantage that the inner wail of vessel 10 does not itself come into contact with the gas, so that this embodiment is particularly advantageous for storing relatively aggressive gases.

Instead of a bladder-like receiving device 44 inside vessel 10, the further embodiment illustrated in FIG. 3 comprises a membrane 50 which is variable in terms of its shape, size and/or position. This membrane 50 serves as a separation device 43, separating first chamber 10 which holds the gas from second chamber 41 which holds the additional fluid 42. In particular, storage devices 1 are relatively low, that is to say there is relatively little distance between first port 31 and second port 45, and can be configured with such a membrane storage device. Membrane 50 is preferably deformable and expandable, so that if can be adapted to various volumes in first chamber 30 and second chamber 41. In an alternative configuration to the embodiment of FIG. 3, a pleated or corrugated bellows, one side of which delimits the gas in the first chamber and the opposite side of which is in contact with the additional fluid may be used instead of a diaphragm 50.

FIG. 4 shows a variant of storage device 1 and a gas storage unit 100, in which no separation means is provided between, gas 20 and additional fluid 42, Here, gas 20 and additional fluid 42 are in a shared chamber 70. A phase boundary 71 forms between gas 20 and additional fluid 42. The volume of first chamber 30 increases or decreases to accommodate gas 20 depending on the fill state of chamber 70 with additional fluid 42. In corresponding manner, the pressure of gas 20 can be kept constant here too when, gas is introduced or extracted. The additional fluid used is preferably an ionic liquid. In order to ensure that the additional fluid 42 is not pumped into the gas system and that the gas 20 does not escape from the system via pressurization controller 31, a float 72 is provided, which is designed to close first port 31 when chamber 70 is completely filled with additional fluid 42 and close second port 43 when chamber 70 is completely filled with gas 20. To ensure this function, storage device 1 preferably comprises a guide 73, as illustrated, to ensure that float 72 is positioned at first port 31 and at second port 45. The ionic liquid is preferably a salt which is liquid at room temperature.

FIG. 5 shows a further embodiment of gas storage unit 100 according to the invention, in which storage device 1 again comprises a chamber 70 holding both gas 20 and additional fluid 42 together. However, in this case the two media are separated by an interposed piston 60, which thus serves as the separation device 43 in this case. In similar manner to the embodiment shown in FIG. 4, here too the pressure of gas 20 may be adjusted by the respective fill level of the additional fluid 42, but there is no direct contact between gas 20 and additional fluid 42. However, any existing cavities between gaskets of piston 60 should not be depressurized, since this can lead to load changes here in the corresponding regions of vessel 10.

If gas 20 and the additional fluid 42 are kept physically separate in extra vessels or in the mutually separated first chamber 30 and second chamber 41 and by the use of pistons with different diameters, a hydraulic transmission may be created between additional fluid 42 and gas 20. This means that in such a variant, no equivalent increase or decrease in the volume of the additional fluid 42 would take place in the event of a corresponding addition or extraction of the gas.

In a variation, of the embodiment shown in FIG. 5 the additional fluid 42 in chamber 70 can be dispensed with, in which case piston 60 would be equipped with a mechanical drive, a spindle for example, with which the volume of gas 20 could be 20 varied in the manner described.

### LIST OF REFERENCE NUMBERS

1 Storage device

10 Vessel

20 Gas

30 First chamber

31 First port

32 Shut-off device

33 Flow path

40 Adjustment device

41 Second chamber

42 Additional fluid

43 Separating device

44 Receiving device

45 Second port

50 Membrane

60 Piston

70 Chamber

71 Phase boundary

72 Float

73 Guide

80 Pump

81 Pressurization controller

82 Drain

100 Gas storage unit

1. A Storage device for storing a gas with a first chamber for receiving the gas and with a shut-off device connected to the flow path for closing and opening the first chamber, characterized in that the storage device comprises an adjustment unit for changing the volume of the first chamber.

2. The storage device according to claim 1, characterized in that the adjustment unit comprises a second chamber for receiving an additional fluid and a separating device, wherein the first chamber and the second chamber are separated by means of the separating device, and the separation device, due to its variability in terms of their shape, size and/or position enables a change in the volume of the first chamber when the volume of the second chamber changes, and vice versa in a certain ratio.

3. The storage device according to claim 2, characterized in that the first chamber has the form of a vessel and the second chamber has the form of a receiving device that is variable with respect to its shape and/or size. cm 4. The storage device according to claim 2, characterized in that the first chamber has the form of a receiving device that is variable with respect to its shape and/or size and the second chamber has the form of a vessel.

5. The storage device according to claim 2, characterized in that the first chamber and the second chamber are arranged in a vessel and are separated from each other by a separation device selected from the group consisting of:
i) a membrane with variable shape and/or size,
ii) a slidable piston, and
iii) a resizable bellows.

6. The storage device according to claim 1, characterized in that that the adjustment unit comprises an additional fluid and a chamber, wherein the additional fluid is located in the chamber and partially delimits the first chamber.

7. The storage device according to claim 1, characterized in that the adjustment unit comprises a restrictor element and a driving member that is mechanically coupled to the restrictor element, wherein the restrictor element least partially restricts the first chamber, and the shape, size and/or position thereof can be varied by the driving member.

8. A gas storage unit comprising a storage device for storing a gas with a first chamber for receiving the gas and with a shut-off device connected to the flow path for closing and opening the first chamber characterized in that the storage device comprises an adjustment unit for changing the volume of the first chamber wherein gas is stored in the first chamber of the storage means.

9. A method for at least partially filling or emptying of a gas storage unit for storing a gas with a first chamber for receiving the gas and with a shut-off device connected to the flow path for closing and opening the first chamber characterized in that the storage, device comprises an adjustment unit for changing the volume of the first chamber in which when a gas volume flow is created into the first chamber or out of the first chamber, the volume of the first chamber is changed in such manner by means of the adjustment unit that the gas pressure in the first chamber is kept substantially constant.

10. The method for at least partially filling or emptying of a gas storage unit according to claim 9, wherein the adjustment unit with a second chamber for receiving an additional fluid and with a separating device the volume of the second chamber is changed by means of a fluid volume flow into the second chamber and out of the second chamber, and the volume of the first chamber is also changed in an opposite manner due to the variation in the shape, size and/or position of the separating means caused thereby.

11. The storage device, according to claim 1, wherein the gas is hydrogen.

12. The storage device, according to claim 6, wherein the additional fluid is ionized fluid.

13. The gas storage unit, according to claim 8, wherein the gas is hydrogen.
